(19) United States
(12) Patent Application Publication
(10) Pub. No.: US 2005/0196112 A1
(43) Pub. Date: Sep. 8, 2005

(54) Transmitting optical subassembly capable of monitoring the front beam of the semiconductor laser diode

(76) Inventor: Toshio Takagi, Yokohama-shi (JP)

Correspondence Address: SMITH, GAMBRELL & RUSSELL, LLP, 1850 M STREET, N.W., SUITE 800, WASHINGTON, DC, 20036, US

(21) Appl. No.: 11/058,424

(22) Filed: Feb. 16, 2005

Related U.S. Application Data
(63) Continuation-in-part of application No. 10/794,406, filed on Mar. 8, 2004.

(51) Int. Cl. G02B 6/36

(52) U.S. Cl. 385/93; 385/88; 385/92; 385/94

(57) ABSTRACT

The present invention provides a light-transmitting subassembly (TOSA), in which the front beam of the laser diode can be monitored by the photodiode. The TOSA includes a package of a CAN-type with a stem, a semiconductor laser diode and a semiconductor photodiode. Not only the photodiode but also the laser diode are mounted on the stem such that the light-emitting facet thereof faces the photo diode, so the light emitted from the light-emitting facet is reflected by the photodiode and guided to a direction perpendicular to the optical axis connecting the light-emitting facet and the photodiode, and guided to the outside of the TOSA.

### CROSS REFERENCE TO RELATED APPLICATION

This application is a continuous-in-part application of U.S. patent application Ser. No. 10/794,406 filed on Mar. 8, 2004.

### BACKGROUND OF THE INVENTION

1. Field of the Invention

The present invention relates to a transmitting optical subassembly, particularly, the present invention relates to an optical subassembly having a coaxial shape package that is able to control in precise its optical output power.

2. Related Prior Art

In a transmitting optical subassembly using a semiconductor laser diode, the automatic power control (hereinafter denoted as APC) is well known technique to maintain an optical output power thereof independently on ambient temperatures. In the conventional APC technique for the semiconductor laser diode having an optical resonator formed by front and rear facets, an optical output from the rear facet is monitored and is fed back to a driving current applied to the semiconductor laser diode.

However, in such APC technique that the optical output is provided from the front facet and the optical monitoring is preformed at the rear facet, a ratio of these optical outputs is not always constant, thereby failing the accuracy of the APC operation. Miss-alignment may occur for optical axes extending from respective facets due to the change of the ambient temperature, or fluctuation of the quantum efficiency within the optical resonator formed by the front and rear facets when the supply current thereto is varied may affect the ratio of the optical output power from respective facets.

One solution for the lack of the consistency between the optical outputs from the front and rear facets, it is known in a prior art that the optical output from the front facet is split into two portions, one of which is for the monitoring and the other is provided for the practical optical output. By using such technique, the lack of the consistency is solved and no compensation is necessary between respective optical outputs. On the other hand, additional optical components such as an optical splitter must be necessary. An optical module with a box-like shaped package, which is generally called as a butterfly package, has enough space to install the optical splitter in front of the front facet of the semiconductor laser diode. However, an optical module having a CAN type package, which is generally called as a coaxial package, is hard to place such optical components in front of the semiconductor laser diode, because an optical axis of the semiconductor laser diode extends to a direction substantially perpendicular to the member mounting the semiconductor laser diode. Therefore, one of object of the present invention is to provide a transmitting optical subassembly having a coaxial shape and being capable of monitoring light emitted from the front facet of the semiconductor laser diode.

### SUMMARY OF THE INVENTION

According to one aspect of the present invention, a transmitting optical subassembly is provided, which has a coaxial shape and comprises a package portion, a semiconductor laser diode and a semiconductor photodiode. The package portion includes a stem having a primary surface, on which the semiconductor laser diode and the semiconductor photodiode are mounted such that a facet of the semiconductor laser diode that emits light faces the semiconductor photodiode. The semiconductor photodiode has a light-reflecting surface that faces the face of the semiconductor laser diode. Accordingly, the light-reflecting surface may reflects light emitted from the facet of the semiconductor laser diode to a direction substantially perpendicular to the primary surface of the stem. The photodiode is also mounted on the primary surface of the stem such that the light-reflecting surface thereof makes a first angle to the primary surface.

Since the transmitting optical subassembly thus arranges the semiconductor devices, the optical output from the front facet of the semiconductor laser diode may be monitored even that the subassembly has the coaxial shape.

The transmitting optical subassembly may further include a lens and a lens holder for holding the lens. The lens holder is mounted on the stem such that the stem and the lens holder form a space for securing the semiconductor laser diode and the semiconductor photodiode therein.

The transmitting optical subassembly of the present invention may further include a sleeve portion that has first to third barrels and a sleeve. The third barrel secures the second barrel and the second barrel secures the sleeve. The first barrel has a side portion, a bore surrounded by the side portion and an end surface. The lens holder may be secured and slid within in the bore for optical alignment along a direction parallel to the first optical axis connecting the photodiode to the sleeve. The second barrel may be slid on the end surface of the first barrel for the alignment in a plane intersecting the first optical axis.

The semiconductor laser diode may be mounted on the primary surface of the stem with a second angle thereto such that the light emitted from the facet of the laser diode propagates in a direction not parallel to the primary surface.

The transmitting optical subassembly may further include a bench that may be made of silicon crystal. The bench has a first mounting surface for the photodiode and a second mounting surface for the laser diode. The first surface may make the first angle to the primary surface, while the second surface may make the second angle to the primary surface. Accordingly, the light emitted from the facet of the laser diode may be reflected by the light-reflecting surface of the photodiode and be output along the direction substantially perpendicular to the primary surface of the stem.

A first optical axis of the light reflected by the light-reflecting surface of the photodiode is preferably perpendicular to a second optical axis connecting the facet of the laser diode to the light-reflecting surface of the photodiode.

The semiconductor photodiode of the present invention may include an optically sensitive semiconductor layer. The optically sensitive layer may be formed adjacent to the light-reflecting surface or adjacent to another surface opposite to the light-reflecting surface. The semiconductor photodiode may be mounted on the stem such that, when the optically sensitive layer exists adjacent to the light-reflecting surface, the optically sensitive layer faces the facet of the laser diode, and, when the optical sensitive layer exists adjacent to the other layer, the optically sensitive layer faces the primary surface of the stem.

The semiconductor photodiode may further include a lens monolithically formed on a surface thereof. The light emitted from the facet of the laser diode enters the monolithic lens, is converted to a substantially parallel beam, reflected by the light-reflecting surface of the photodiode, and focused by the monolithic lens. Accordingly, in this arrangement, the lens provided above the stem may be omitted.

The stem of the present invention may include a plurality of lead terminals. The top portion of lead terminals extrudes from the primary surface of the stem and has a cur surface substantially in parallel to at least one of the electrode of the laser diode and that of the photodiode. Accordingly, when the wire boding between the electrode and the lead terminal, the stem is not necessary to rotate to secure the constant condition for the wire bonding process.

The top of the lead terminal may be a cone shape, the side surface of which is substantially in parallel to at least one of electrodes of the laser diode and the photodiode. The top of the lead terminal may be chamfered, and the chamfered surface is substantially in parallel to the electrodes. It may be applicable that an attachment, made of metal and having a wedge shape, is fixed on the top surface of the lead terminal such that one surface of the wedge shaped attachment faces the top of the lead terminal and the other surface thereof is substantially in parallel to one of the electrodes of the laser diode and the photodiode.

### BRIEF DESCRIPTION OF DRAWINGS

FIG. 1 is a schematic view showing the inside of the transmitting optical subassembly according to the present invention;

FIG. 2 is an expanded view showing the package portion of the transmitting optical subassembly;

FIG. 3 shows a package portion of the transmitting optical subassembly according to the second embodiment;

FIG. 4 shows another package portion of the transmitting optical subassembly according to the third embodiment of the present invention;

FIG. 5 shows a fourth embodiment of the package portion of the present invention;

FIG. 6 is a cross sectional view showing the fourth embodiment of the present invention.

FIG. 7A is a perspective view showing the fifth embodiment of the present invention, and FIG. 7B shows a process of the wire bonding for the transmitting optical subassembly of the fifth embodiment;

FIG. 8A shows a modified shape of the top of the lead terminals, and FIG. 8B shows another modified shape of the top of the lead terminal; and

FIG. 9 shows still another modified shape of the top of the lead terminal.

### DETAILED DESCRIPTION OF PREFERRED EMBODIMENTS

Next, preferred embodiments of the present invention will be described as referring to accompanying drawings. In the drawings, same elements will be referred by same symbols or numerals without overlapping explanation.

### First Embodiment

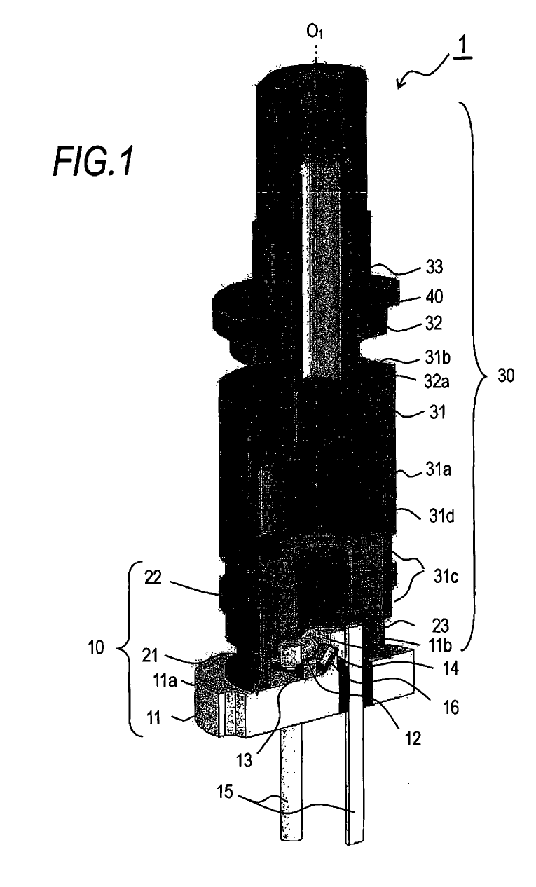

FIG. 1 is a partial cross sectional view showing a transmitting optical subassembly (hereinafter denoted by TOSA) 1 according to the present invention. The TOSA 1 comprises a package portion 10 and a sleeve portion 30.

The package portion 10 includes a stem 11, a plurality of lead terminals 15, a lens holder 21, a lens 22, a semiconductor laser diode (hereinafter denoted as LD) 12, a heat sink 13 and a photodiode (hereinafter denoted as PD) 14. These elements are installed in a space 23 formed by the lens holder 21 and the stem 11 with hermetically sealing arrangement. The stem 11 has a disk shape with a diameter of typically from 3 mm to 6 mm and is made of metal such as iron plated by nickel and gold. The LD 12 is mounted on a center portion of the primary surface 11a of the stem 11 via the heat sink 13, while the PD 14 is mounted on a slant surface 11b of the stem 11, the surface 11b may be formed by, for instance, heaping. Around the center portion of the stem 11, the plurality of lead terminals 15 is provided. The LD 12 and the PD 14 are wire-bonded to a tip of the lead terminal 15. A gap between the lead terminal 15 and an inner surface of the hole, the lead terminal 15 is passing therethrough, is filled with a sealing glass, thereby hermetically sealing the space 23 formed by the stem 11 and the lens holder 21 from the outside.

The sleeve portion 30 includes first to third barrels 31, 32 and 33, and a sleeve 40. The first barrel 31 has a side portion 31a covering the outer surface of the lens holder 21, and an end portion 31b. The lens holder 21 is secured within the bore 31d of the first barrel 31. By sliding the inner surface of the bore 31d on the outer surface of the lens holder 21, an optical alignment of the sleeve portion 30 along the first optical axis O₁, which connects the PD 14 to the sleeve 40, may be performed. The first barrel 31 has a plurality of thin walls 31c in its outer surface, where the first barrel 31 and the lens holder 21 are permanently welded with the YAG-laser. The first barrel may further include an optical isolator within the bore 31d. The optical isolator is attached to the inner surface of the bore 31d. The first barrel 31 and the lens holder 21 may be welded such that the first barrel 31 covers the isolator and the lens holder 21.

The second barrel 32 and the third barrel 33 secure the sleeve 40 therein. The second barrel 32 is press-fitted into a gap formed between the sleeve 40 and the third barrel 33, thereby preventing the sleeve 40 from falling out from the third barrel 33. The end portion 31b of the first barrel 31 and an end surface 32a of the second barrel 32 are plane surfaces such that the optical alignment across the first optical axis O₁ is performed by sliding the second barrel 32 on the end surface 31b of the first barrel 31. The end surface 32a of the second barrel 32 has a flange with such thickness that the YAG-laser welding may be applicable to permanently fix the second barrel 32 to the first barrel 31. The sleeve 40 is typically type of split sleeve made of zirconia ceramic, or a rigid sleeve made of metal or zirconia ceramic may be applicable to the present invention. The first to third barrels 31, 32 and 33 are made of metal.

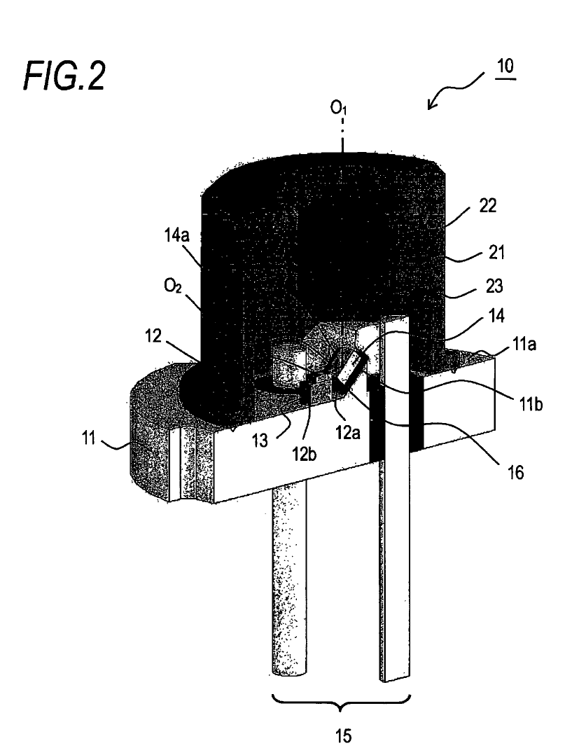

FIG. 2 is a magnified view showing the package portion 10 and an arrangement of optical semiconductor devices mounted in the package portion 10. The stem 11 has a disk shape made of iron with a thickness of about 1.2 mm. A center portion of the stem 11 is processed such that the mounting surface 11b is protruding from the primary surface 11a of the stem 11 and has an angle of about 45° to the first optical axis O₁. The PD 14 is mounted on the mounting surface 11b via a sub-mount 16, thereby making the light-reflecting surface 14a of the PD 14 an angle of about 45° against the first optical axis O₁.

The LD 12 is mounted on the primary surface 11a of the stem 11 adjacent to the mounting surface 11b via a heat sink 13. The LD 12 has a first facet 12a and the second facet 12b, which form an optical cavity of the LD 12, and is mounted such that the first facet 12a faces to the light-reflecting surface 14a of the PD 14. The heat sink 13 has a dice shape so that an axis connecting the first facet 12a and the second facet 12b of the LD 12 is nearly parallel to the primary surface 11a of the stem 11.

In this arrangement, the light emitted from the first facet 12a enters the PD 14 along a second optical axis of nearly parallel to the primary surface 11a of the stem 11. Since the mounting surface 11b of the PD 14 has angle of about 45° to the primary surface 11a of the stem 11, the light incident to the light-reflecting surface 14a of the PD 14 and reflected thereby heads a direction substantially perpendicular to the primary surface 11a of the stem 11. The reflected light enters the lens 22 and is focused thereby to the optical fiber, which is not shown in FIG. 2, that is aligned with the sleeve 40.

According to the arrangement thus described, the light emitted from the LD 12 enters the PD 14, reflected thereby and output from the optical fiber aligned with sleeve 40. While, the PD 14 can monitor the magnitude of the same light as that of output form the subassembly, which enables an automatic power control (hereinafter denoted by APC) of a bias current and a modulation current of the LD 12. Thus, a front monitoring of the emitted light from the LD 12 may be realized in the TOSA having the coaxial shape package.

### Second Embodiment

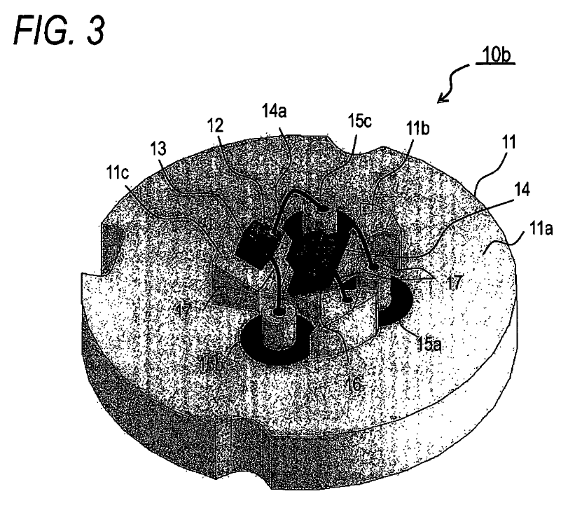

FIG. 3 is a perspective view of the TOSA 10b according to the second embodiment of the present invention. In the TOSA 10b, the center portion of the stem 11 is so processed in protrusive that the mounting surface 11b for the PD 14 and the other mounting surface 11c for the LD 12 are provided. These mounting surfaces 11b and 11c make an angle of 120° to each other. The PD 14 is mounted on the mounting surface with wiring patterns being formed thereon. One terminal and the other terminal of the PD 14 are connected to the stem 11 and the lead terminal 15 through the wiring patterns on the sub-mount 16 and bonding wires 17. The LD 12 is mounted on the mounting surface 11c via the heat sink 13. The heat sink 13 is also made of insulating material with good thermal conductivity, typically aluminum nitride (AlN). On the heat sink 13, an electrical pad to be connected to the electrode of the LD 12 and the lead terminal 15b is provided.

The heat sink 13 is placed on the mounting surface 11c such that the first facet 12a of the LD 12 faces the light-reflecting surface 14a of the PD 14. One electrode of the LD 12 is directly wire-bonded with the lead terminal 15c, while the other electrode thereof is electrically connected to another lead terminal 15b via the electronic pad on the heat sink and a bonding wire 17.

In the present embodiment, the light emitted from the first facet 12a of the LD 12 heads the PD 14 and is reflected by the light-reflecting surface 14a of the PD 14. Since the mounting surface 11b for the PD 14 and that 11c for the LD 12 has the predetermined angle, the light reflected by the light-reflecting surface 14a of the PD 14 heads the direction perpendicular to the primary surface 11a of the stem 11, and enters the optical fiber provided in the sleeve 40 via the lens 22. Thus, the PD 14 for monitoring the output light from the LD 12 may be installed in the front side of the LD 12, which enables the APC with superior accuracy.

### Third Embodiment

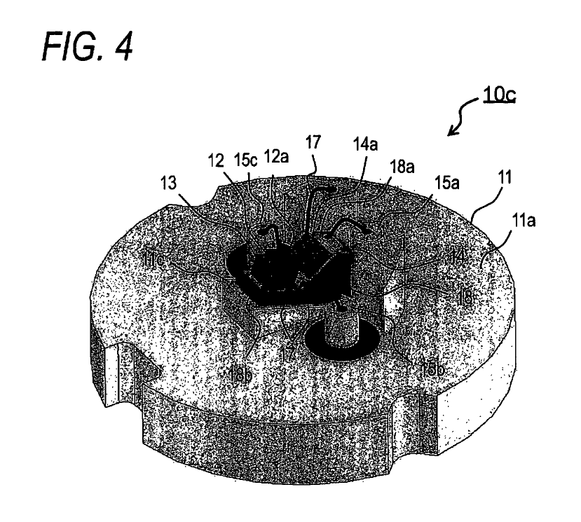

FIG. 4 is a perspective view showing the third embodiment of the present invention. The package portion 10c of the present embodiment includes a bench 18 for mounting the LD 12 and the PD 14 thereon. The bench 18 may be made of silicon crystal. The bench 18 is placed on the mounting surface 11c, which is processed so as to protrude from the primary surface 1a of the stem 11 and make a predetermined angle thereto.

The bench 18 includes the mounting surface 18a for the PD 14 and another mounting surface 18b for the LD 12. The PD 14 is directly placed on the mounting surface 18a, while the LD 12 is mounted on the mounting surface 181b via the heat sink 13. The heat sink 13, as previously described, is made of aluminum nitride (AlN), on which the electronic pad is provided for placing the LD 12. The one terminal of the PD 14 is wire-bonded to the lead terminal 15a, and the other terminal thereof that is practically the back surface of the PD 14, is directly connected to the stem 11 via the protruding portion. The electrical wiring for the LD 12, as shown in the previous embodiments, is carried out such that the upper surface thereof is directly wire-bonded to one of lead terminals 15c, while the other electrode of the lower surface thereof is connected to other lead terminal 15b via the electronic pad on the head sink 13.

Also in the present configuration of the package portion 10c, the light emitted from the first facet 12a of the LD 12 heads the PD 14 and is reflected by the primary surface thereof. Since the bench 18 has tow surfaces, each makes predetermined angles to the primary surface 11a of the stem 11 and the PD 14 mounted on one of the mounting surface 18a, the light reflected by the light-reflecting surface 14a of the PD 14 heads the lens 22 provided above the PD 14 with an angle slightly tilted from the direction perpendicular to the primary surface 11a of the stem 11. Accordingly, light reflected by the surface of the lens 22 does not return to the PD 14 and the LD 12, which suppresses the optical noise for the LD 12 and enhances the accuracy of light monitoring.

### Fourth Embodiment

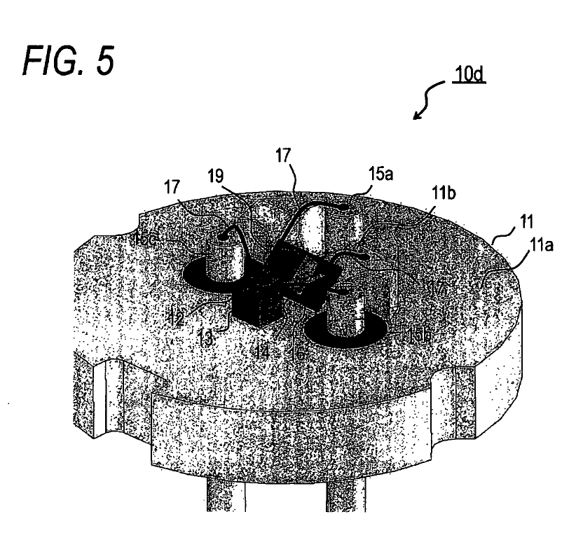

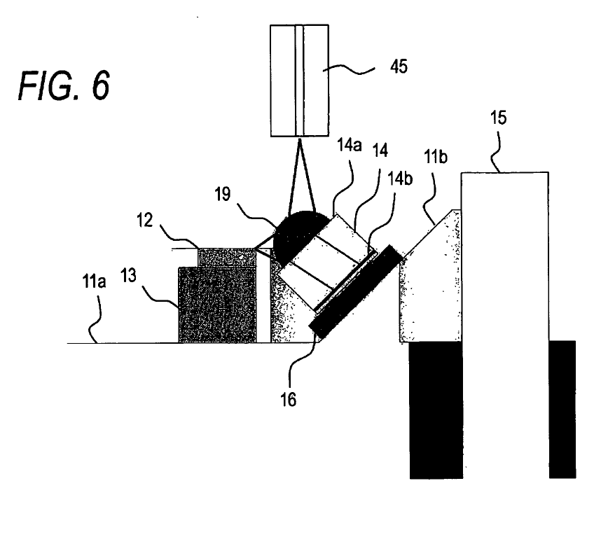

FIG. 5 and FIG. 6 are views showing a structure of the PD 14 according to the fourth embodiment of the present invention. In this embodiment, only the arrangement of the PD 14 is modified from the first embodiment shown in FIG. 1 and FIG. 2. The PD 14 is mounted on the mounting surface 11b via the sub-mount 16. The sub-mount 16 is an insulator with wiring patterns being formed thereon. The PD 14 is connected to the sub-mount 16 by the flip-chip bonding technique. In this arrangement, the surface of the PD 14, where an optical sensitive semiconductor layer 1b is formed adjacent thereto, faces the sub-mount 16.

The light-reflecting surface 14a of the PD 14 provides a lens 19 monolithically formed with an inorganic film such as silicon nitride for passivating the light-reflecting surface 14a of the PD 14. The focal length of this monolithic lens 19 is about 80 am. Accordingly, as shown in FIG. 6, the light emitted from the LD 12 on the heat sink 13 is converted to a nearly parallel beam by the surface of the lens 19 and reflected by the light-reflecting surface 14a of the PD 14. Portion of light, not reflected at the surface of the PD 14 and transmits therethrough, enters the optical sensitive semiconductor layer 14b formed adjacent to the surface of the PD 14.

On the other hand, the light reflected by the light-reflecting surface 14a of the PD 14 heads the lens 22 along the direction nearly perpendicular to the primary surface 11a of the stem 11, and is focused by the surface of the monolithic lens 19. Accordingly, when the optical fiber 45 is placed such that the tip thereof coincides with the focus of the monolithic lens 19, the lens 22 provided above the stem 11 may be omitted. Also in the present embodiment, the front light of the LD 12 may be detected by the PD 14 even in the TOSA having the coaxial package, which enhances the accuracy of the APC operation.

### Fifth Embodiment

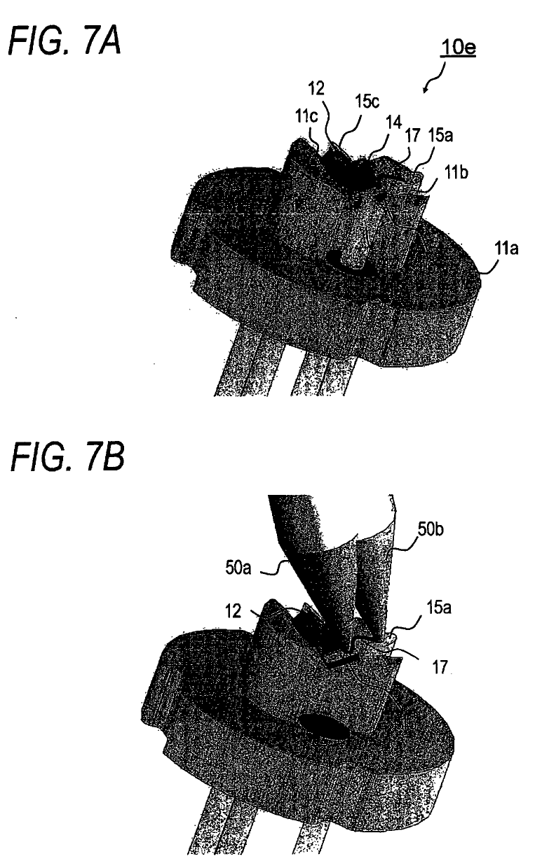

FIG. 7A and FIG. 7B show a fifth embodiment of the present invention. In the optical sub-assembly 10e of the present invention, the LD 12 is mounted on the mounting surface 11c formed on and inclined to the primary surface 11a of the stem 11, or may be mounted on the mounting surface 11b of the bench 18, which is installed on the stem 11, thus the mounting surface 1b of the bench 18 is inclined to the primary surface 11a of the stem 11. The electrical connection to the semiconductor devices, the LD 12 and the PD 14, are carried out by respective bonding wires 17 from corresponding lead terminals 15 to the devices.

Some manufacturing processes such as ultrasonic bonding or thermo-compression bonding well known in the field of the semiconductor manufacturing may be applied for the wire bonding of the present sub-assembly 10e. However, these bonding technique require that two electrodes to be connected by the bonding wire must exist in planes substantially parallel to each other. When the compressive stress between the bonding wire and the electrode to be connected can not be maintained in constant, which is caused by the angle between the bonding tool and the electrode, not only the bonding strength but also the wire strength are scattered, thereby degrading there liability of the optical sub-assembly.

In the TOSA 1 having configurations thus explained, since the top of the lead terminals 15 are arranged to be flat, i.e., substantially in parallel to the primary surface 11a of the stem 11, the stem 11 is necessary to be rotated after the first bonding to the electrode of the LD 12 or the PD 14 and before the second bonding to the top surface of the lead terminals 15, such that the top of the lead terminals 15 becomes perpendicular to the bonding tool.

FIG. 7A and FIG. 7B show an arrangement of the top of the lead terminals 15 to save the rotation of the stem 11 and the process of the bonding to such lead terminals 15, respectively. As shown in FIG. 7A, the top of the lead terminals 1a is cut such that the section becomes substantially in parallel to the electrode of the PD 14, the front surface of sub-mount 16, or the mounting surface 1b for the PD 14. Similarly, top surfaces of the other lead terminals 15b and 15c are cut such that the sections of respective lead terminals 15b and 15c become substantially in parallel to the electrode of the LD 12, or the mounting surface 11c for the LD 12. Accordingly, the top surfaces of respective lead terminals 15a, 15b and 15c are inclined to the primary surface 11a of the stem 11.

FIG. 7B shows a process of the wire bonding between the wiring pattern formed on the sub-mount 16 for the PD 14 and the top of the lead terminal 15a thus configured. First, the wire bonding to the wiring pattern on the sub-mount is carried out. The bonding wire is pulled out from the tip of the capillary 50a with a length comparable to that of the wiring pattern, and the ultrasonic bonding or the thermo-compression bonding is carried out for the pulled-out wire. Next, moving the capillary 50a to the lead terminal 15a without rotating the stem 11, the position is shown by the capillary 50b in FIG. 7E, the second bonding is carried out to the top of the lead terminal 15a. By pressing the wire to the top of the lead terminal 15a, the wire may be cut at that position. In this two step bonding, the first to the electrode and the second to the lead terminal, the stem 11 is not necessary to rotate at all. In FIG. 7B, the lead terminal 15b is omitted for the explanation sake.

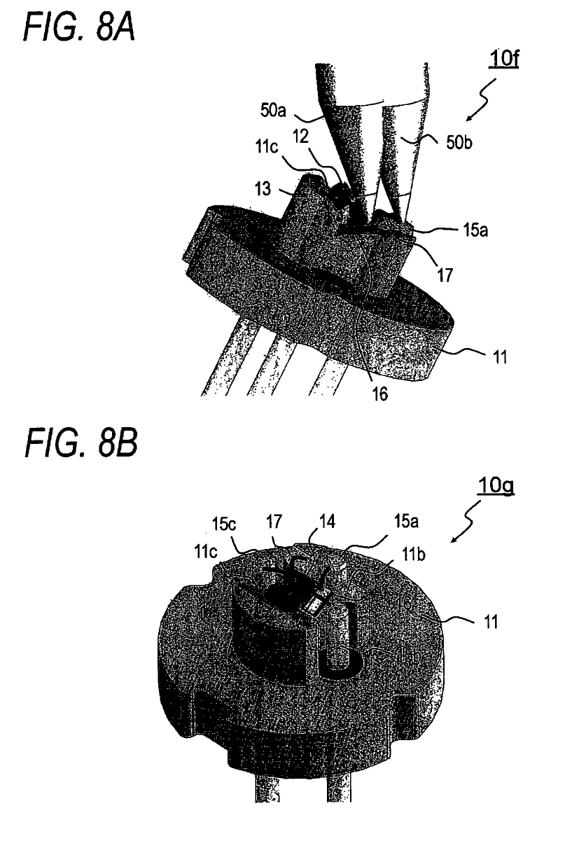

FIG. 8A shows a modification of the top shape of the lead terminal 15a, 15b and 15c. In this modified configuration, the top of the lead terminals 15a, 15b and 15c are processed in a cone, the side surface of which is substantially in parallel to the electrode of the LD 12, that of the PD 14 or the front surface of the sub-mount 13 and 16.

FIG. 8B shows still another modification of the top shape of the lead terminals 15a, 15b and 15c. In these lead terminals 15a, 15b and 15c, the tops thereof are processed to a cone shape, and further tops thereof are configured to have a plane substantially in parallel to the surface 11a of the stem 11. That is, the top portion of the each lead terminals 15 is chamfered such that the chamfered surface is substantially in parallel to the electrode of the LD 12 and that of the PD 14. The wire bonding is carried out to these chamfered surfaces. Since the wire bonding using the capillary 50 can be performed to a substantially flat surface with a few hundred micron meters square, the lead terminal 15 having a cone shape top may be wire bonded with ease because the diameter of the lead terminal 15 is about 0.2 mm or more.

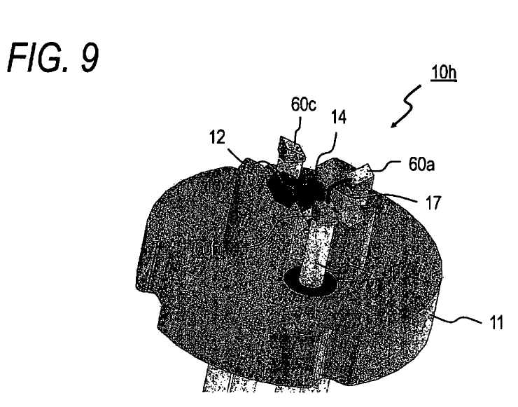

FIG. 9 shows still another modification of the lead terminal 15. In this embodiment, attachments 60a to 60c are fixed to respective lead terminals 15a, 15b and 15c whose top surfaces are processed in parallel to the primary surface 11a of the stem 11, as those of conventional lead terminals. Since the attachments 60a to 60c are formed in a wedge shape, one of surfaces thereof becomes substantially in parallel to the electrode of the LD 12, PD 14, or the surface of the sub-mount 13 and 16, when these attachments 60a to 60c are fixed on the top surface of the lead terminal 15. These attachments 60a to 60c may be made of Kovar or iron. Also in this configuration, the stem 11 is not necessary to rotate between the first and the second bonding processes.

From the invention thus described, the invention and its application may be varied in many ways. Such modification and variation are not to be regarded as a departure from the spirit and scope of the invention, and all such modifications as would be obvious to one skilled in the art are intended for inclusion within the scope of the following claims.

1. A transmitting optical subassembly, comprising:
a package portion having a co-axial shape, said package portion including a stem with a primary surface;
a semiconductor laser diode mounted on said primary surface, said semiconductor laser diode having a facet for emitting light; and
a semiconductor photodiode having a light-reflecting surface facing said facet of said semiconductor laser diode, said light-reflecting surface reflecting said light emitted from said facet of said semiconductor laser diode to a direction substantially perpendicular to said primary surface of said stem, said semiconductor photodiode being mounted on said primary surface of said stem such that said light reflecting surface of said semiconductor photodiode makes a first angle to said primary surface of said stem,
wherein said transmitting optical sub-assembly outputs said light reflected by said light reflecting surface of said semiconductor photodiode.

2. The transmitting optical subassembly according to claim 1, wherein said package portion further comprises a lens and lens holder for holding said lens, said lens focusing said light reflected by light reflecting surface of said semiconductor photodiode, said lens holder being mounted on said stem such that said stem and said lens holder forms a space for securing said semiconductor laser diode and said semiconductor photodiode therein.

3. The transmitting optical subassembly according to claim 2,
further comprises a sleeve portion including first to third barrels and a sleeve secured by said second and third barrels, said sleeve forming a first optical axis to said semiconductor photodiode,
wherein said first barrel has a side portion, a bore formed by said side portion and an end surface, said lens holder being secured and capable of sliding within said bore for optical alignment along a direction parallel to said first optical axis, said second barrel being capable of sliding on said end surface of said first barrel for optical alignment in a plane intersecting said first optical axis.

4. The transmitting optical subassembly according to claim 1, wherein said semiconductor laser diode is mounted on said primary surface with a second angle to said primary surface of said stem, said light emitted from said facet of said semiconductor laser diode propagating along in a direction not parallel to said primary surface of said stem.

5. The transmitting optical subassembly according to claim 4, further comprises a bench mounted on said primary surface of said stem, said bench having a first mounting surface for mounting said semiconductor photodiode and a second mounting surface for mounting said semiconductor laser diode, said first mounting surface making said first angle to said primary surface of said stem and said second mounting surface making said second angle to said primary surface of said stem.

6. The transmitting optical subassembly according to claim 5, wherein said bench is made of silicon crystal.

7. The transmitting optical subassembly according to claim 1, wherein said first optical axis is substantially perpendicular to a second optical axis connecting said facet of said semiconductor laser diode to said light-reflecting surface of said semiconductor photodiode.

8. The transmitting optical subassembly according to claim 1,
wherein said semiconductor photodiode further includes an optically sensitive semiconductor layer adjacent to said light-reflecting surface of said semiconductor photodiode, and
wherein said semiconductor photodiode is mounted such that said light-reflecting surface faces said semiconductor laser diode.

9. The transmitting optical subassembly according to claim 1,
wherein said semiconductor photodiode further includes an optically sensitive semiconductor layer adjacent to another surface opposite to said light-reflecting surface, and
wherein said photodiode is mounted such that said another surface faces said primary surface of said stem.

10. The transmitting optical subassembly according to claim 9,
wherein said semiconductor photodiode further includes a lens monolithically formed on said light-reflecting surface, said light emitted from said facet of said semiconductor laser diode entering said monolithic lens, being converted to a substantially parallel beam, said parallel beam being reflected by said light-reflecting surface of said semiconductor photodiode, and said light reflected by said light-reflecting surface of said semiconductor photodiode being focused by said monolithic lens.

11. The transmitting optical subassembly according to claim 1, further includes a plurality of lead terminals secured by and passing through said stem,
wherein said plurality of lead terminals has a top extruding from said primary surface of said stem, said top having a cut surface substantially parallel to at least one of an electrode of said semiconductor laser diode and an electrode of said semiconductor photodiode.

12. The transmitting optical subassembly according to claim 1, further includes a plurality of lead terminals secured by and passing through said stem,
wherein said plurality of lead terminals has a top extruding form said primary surface of said stem, said top having a cone shape with a side surface substantially parallel to at least one of an electrode of said semiconductor laser diode and an electrode of said semiconductor photodiode.

13. The transmitting optical subassembly according to claim 1, further includes a plurality of lead terminals secured by and passing through said stem,
wherein said plurality of lead terminals has a top extruding from said primary surface of said stem, said top having a chamfered surface substantially parallel to at least one of an electrode of said semiconductor laser diode and an electrode of said semiconductor photodiode.

14. The transmitting optical subassembly according to claim 1, further includes a plurality of lead terminals secured by and passing through said stem, and
a plurality of attachments made of metal and having a wedge shape with two surfaces opposite to each other,
wherein each attachment is fixed on a top surface of said lead terminal extruding from said primary surface of said stem such that one of surfaces of said wedge shaped attachment faces to said top surface of said lead terminal and the other surface is substantially in parallel to one of an electrode of said semiconductor laser diode and an electrode of said semiconductor photodiode.
